(19) United States
(12) Patent Application Publication
(10) Pub. No.: US 2023/0065961 A1
(43) Pub. Date: Mar. 2, 2023

(54) Room Air Purifier with Locking Ring

(71) Applicant: 3M INNOVATIVE PROPERTIES COMPANY, St. Paul, MN (US)

(72) Inventors: Brian D. Gale, Blaine, MN (US); Andrew R. Fox, Oakdale, MN (US)

(21) Appl. No.: 17/888,997

(22) Filed: Aug. 16, 2022

Related U.S. Application Data
(60) Provisional application No. 63/238,845, filed on Aug. 31, 2021.

(51) Int. Cl. F24F 8/108; F24F 13/28

(52) U.S. Cl. CPC F24F 8/108; F24F 13/28

(57) ABSTRACT

A room air purifier including first and second portions. The first portion includes a locking ring and the second portion includes a mandrel configured to receive an unframed air filter. The locking ring can be secured to the mandrel to join the first and second portions to each other to form the room air purifier.

### CROSS REFERENCE TO RELATED APPLICATIONS

This application claims priority from U.S. Provisional Application Ser. No. 63/238845, filed 31 Aug. 2022, the disclosure of which is incorporated by reference in its/their entirety herein.

### BACKGROUND

Room air purifiers are often used to purify (e.g., to remove at least some fine particles from) ambient air e.g. in rooms of houses, condominiums, apartments, offices, and so on.

### SUMMARY

In broad summary, herein is disclosed a room air purifier comprising first and second portions and methods of joining the portions to each other to form the room air purifier. The first portion comprises a locking ring and the second portion comprises a mandrel configured to receive an unframed air filter. The locking ring can be secured to the mandrel to join the first and second portions to each other to form the room air purifier. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a front-side perspective view of an exemplary room air purifier as disclosed herein.

FIG. 2 is a front-side perspective view of an exemplary room air purifier, partially exploded into a first, upper portion and a second, lower portion.

FIG. 3 is a bottom view of a first, upper portion of an exemplary room air purifier, looking upwards along the vertical axis.

FIG. 4 is a top view of a second, lower portion of an exemplary room air purifier, looking downwards along the vertical axis.

FIG. 5 is a front perspective isolated view of an exemplary mandrel of a second, lower portion of a room air purifier, and further depicting exemplary upper and lower gaskets.

FIG. 6 is a front perspective isolated view of an exemplary air filter for a room air purifier, and further depicting exemplary upper and lower gaskets.

FIG. 7 is a top perspective isolated view of an exemplary mandrel and an exemplary locking ring that can be used to secure the mandrel to a first, upper portion of a room air purifier.

FIG. 8 is a top perspective isolated view of the mandrel and locking ring of FIG. 7, with a lower section of the first, upper portion of the room air purifier omitted.

FIG. 9 is a top perspective isolated view of an exemplary locking ring.

FIG. 10 is a magnified view of the locking ring of FIG. 9, shown from a different perspective.

FIG. 11 is a top perspective view of the mandrel of FIG. 7, with the locking ring omitted.

FIG. 12 is a magnified view of an upper section of the mandrel of FIG. 11, depicting J-apertures in a collar of the mandrel.

FIG. 13 is a perspective view looking upward at the underside of a lower section of a first, upper portion of an exemplary room air purifier.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

Although terms such as “first” and “second” may be used in this disclosure, it should be understood that those terms are used in their relative sense only unless otherwise noted. As used herein as a modifier to a property or attribute, the term “generally”, unless otherwise specifically defined, means that the property or attribute would be readily recognizable by a person of ordinary skill but without requiring absolute precision or a perfect match. The term “substantially”, unless otherwise specifically defined, means to a high degree of approximation but again without requiring absolute precision or a perfect match.

### DETAILED DESCRIPTION

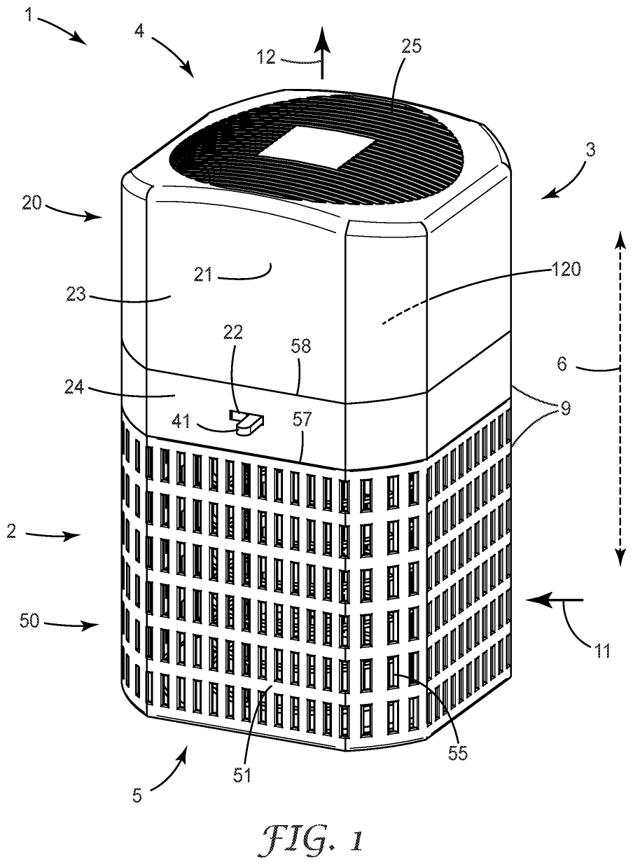

Shown in FIG. 1 in front-side perspective view is an exemplary powered room air purifier 1. Room air purifier 1 includes a housing 9 defining at least one air inlet 55, at least one air outlet 25, and an airflow path therebetween. Room air purifier 1, when positioned for ordinary operation (e.g. upright on a floor or tabletop) may often exhibit a front side 2, a rear side 3, and a top 4 and a bottom 5. Such a room air purifier will often exhibit a longitudinal axis that, when the room air purifier is positioned for ordinary operation, will at least generally coincide with a vertical axis as defined by Earth's gravity. The longitudinal/vertical axis LN for exemplary room air purifier 1 is identified (by way of arrow 6) in FIG. 1. However, it is noted that all such directional terms are used for convenience and clarity of description and have no limiting meaning with regard to how any particular room air purifier may be positioned or oriented for actual use within a room.

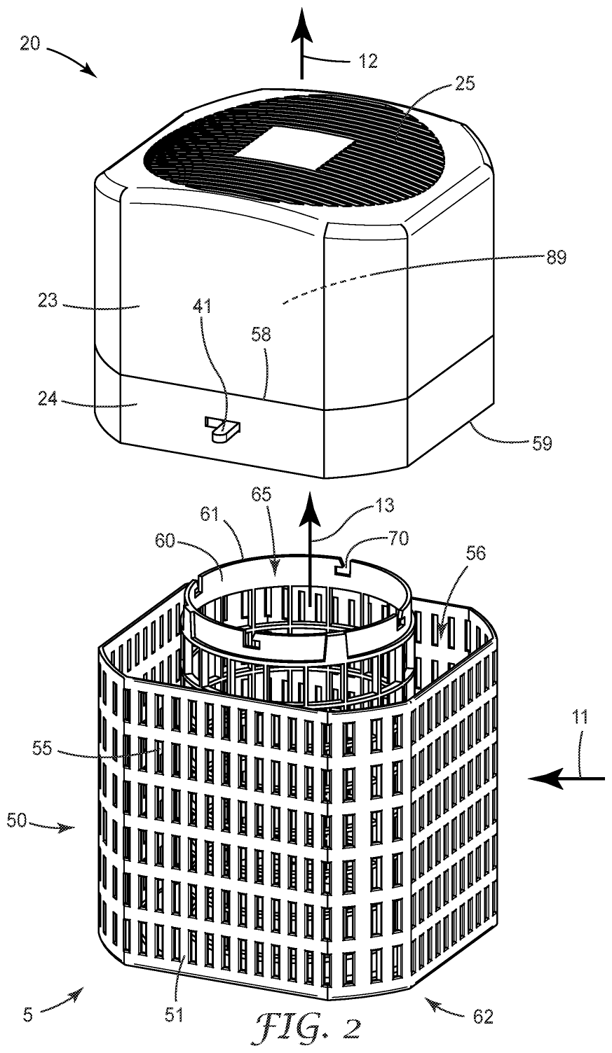

The exemplary room air purifier 1 as depicted in FIG. 1 is comprised of first and second portions 20 and 50, as shown in exploded view of FIG. 2. Portions 20 and 50 are joined together as disclosed herein to form room air purifier 1. Portion 20 will be referred to as an upper portion and portion 50 will be referred to as a lower portion. However, as noted above, this does not limit the orientation into which any such room air purifier may be positioned. Upper and lower portions 20 and 50 respectively comprise upper and lower housing pieces 21 and 51 (made e.g. of molded plastic) that collectively provide the overall housing 9 of the room air purifier. Upper and lower housing pieces 21 and 51 may meet at a junction 57 as indicated in FIGS. 1 and 2. In the depicted embodiment, upper housing piece 21 is further subdivided into separately-made upper and lower sections 23 and 24 with a junction 58 therebetween. However, this arrangement is largely a feature of the manner in which the exemplary prototype room air purifier components were made (e.g. via 3-D printing). In many embodiments, sections 23 and 24 may be integral sections of an upper housing piece 21 that is a single, unitary structure made e.g. by injection molding.

Room air purifier 1 will comprise an airflow path therethrough. In the exemplary depiction of FIGS. 1 and 2, ambient air will enter air inlet 55 as indicated by arrow 11, will pass into an airspace 56, and from there will pass through an air filter (not shown in FIG. 2) that is disposed on mandrel 60, and from there will enter a filtered airspace 65 within mandrel 60. From there the filtered air will pass upwards as indicated by arrow 13 into an upper filtered-air space 89 within upper portion 20 of the room air purifier, with the filtered air exiting through air outlet 25 as indicated by arrow 12. Air inlet(s) 55 and outlet(s) 25 may be at any suitable location and in any suitable number. For example, air inlets 55 are only visible on two sides of the room air purifier from the vantage point of FIGS. 1 and 2, but in many embodiments inlets may be provided on all four sides of the room air purifier (or, if the room air purifier is generally cylindrical in shape, a single air inlet may extend around most or all of the circumference of the housing of the room air purifier).

Room air purifier 1 includes at least one fan 120 (indicated generically in FIG. 1) that motivates ambient air to enter the room air purifier and pass through an air filter installed therein and to exit the room air purifier as filtered air. In many convenient embodiments, such a fan 120 may be an axial fan that is positioned within the upper portion 20 of the room air purifier. By definition, room air purifier 1 is a powered room air purifier, meaning that fan 120 is a powered fan that is driven by electric power, possibly from an internal power source (e.g. battery) but more typically delivered through a cord from an external power source. No cord is shown in the Figs. herein but such a cord may enter the upper portion 20 of the room air purifier via a port 121; the lower portion 50 of the room air purifier may comprise a cord guide 122 to facilitate the positioning of the cord.

In many embodiments, the upper portion 20 of the room air purifier will comprise not only the powered fan 120, but also any control circuitry, switches, visual indicators, and so on, as are needed to operate the room air purifier. In many such embodiments the lower portion 50 of the room air purifier will not have any components that require electric power, thus in such embodiments there is no reason to equip lower portion 50 with an electrical cord or to provide any kind of electrical connection between upper portion 20 and lower portion 50.

Control circuity of the room air purifier may be of any suitable type and may include any appropriate components. The control circuitry will be in operative connection with fan 120 (e.g. so that the fan can be turned on and off and operated at different speeds if desired) and is also in operative connection with various controls and switches, monitors, displays and/or indicators, etc., that allow a user to directly operate room air purifier 1. In some embodiments, the control circuitry may include a wireless communication unit that allows the control circuitry to communicate with an external device. Such arrangements can allow the room air purifier to be operated (and/or its operating status monitored) remotely rather than being operated directly by way of controls located on the room air purifier itself

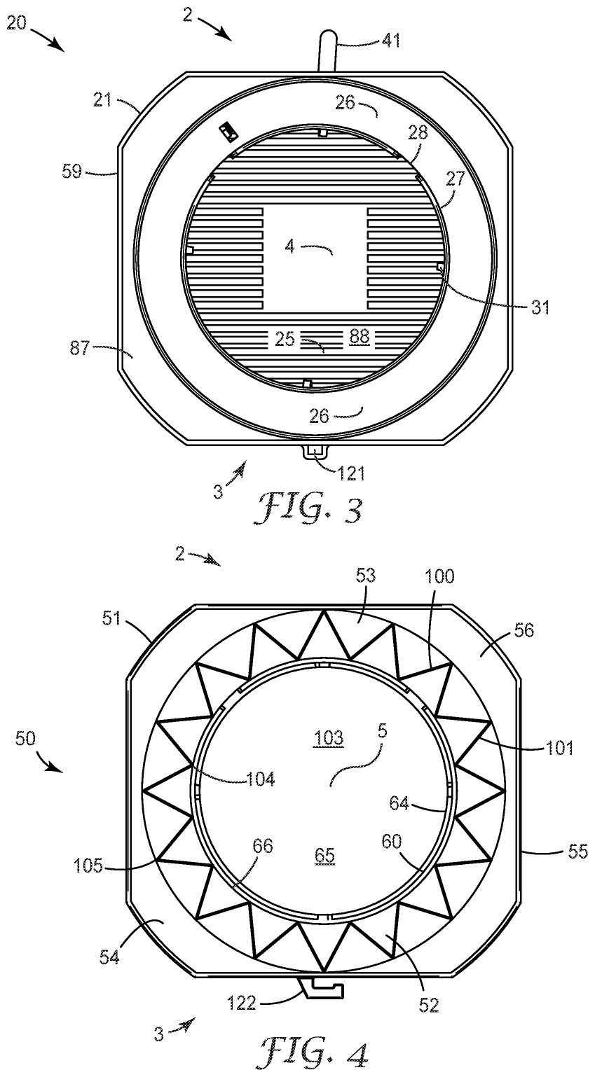

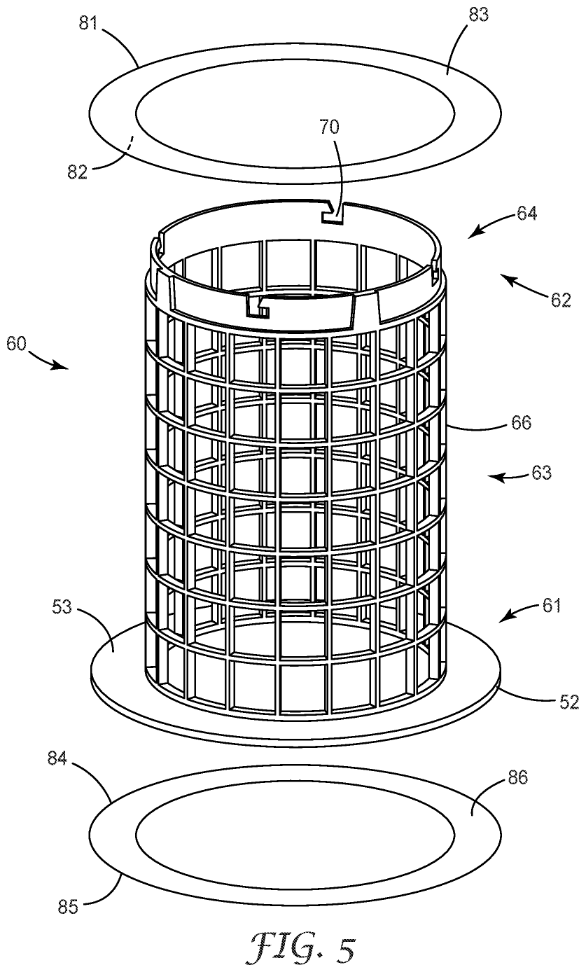

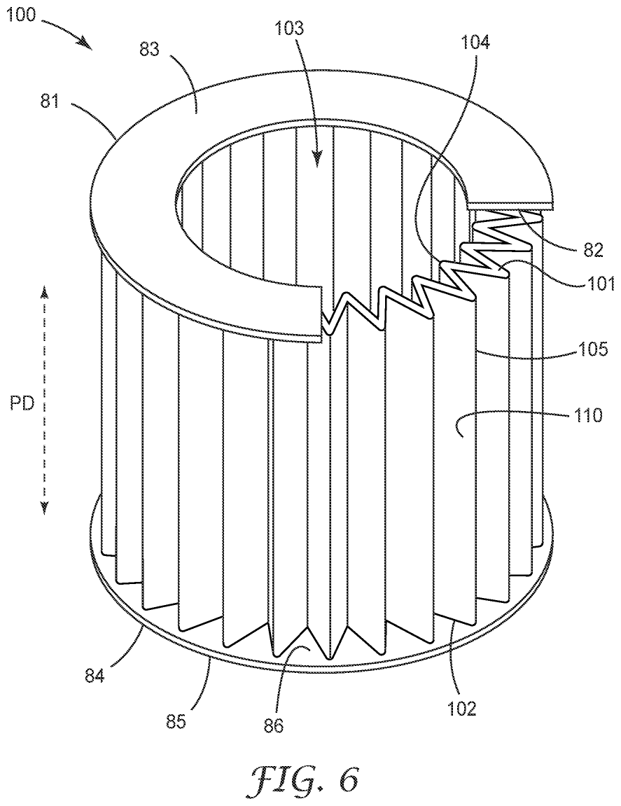

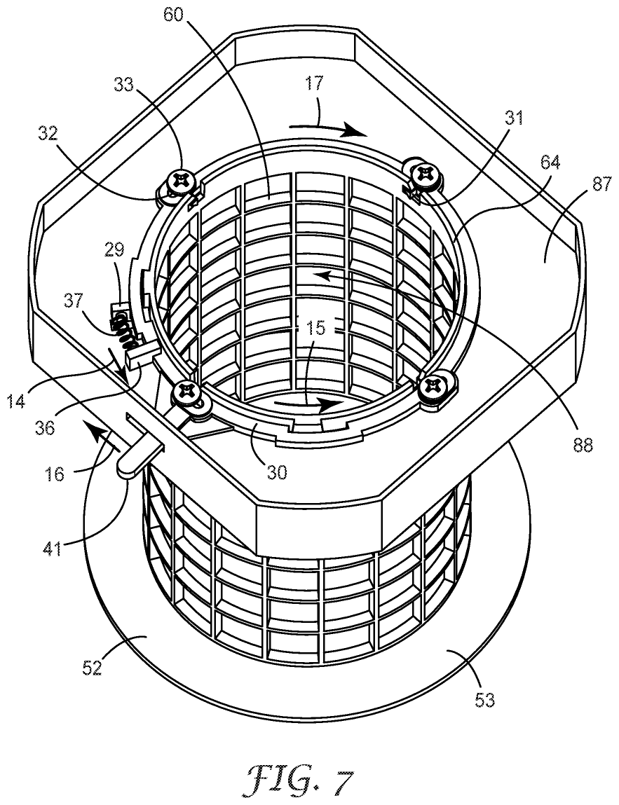

Lower portion 50 of room air purifier 1 will comprise a mandrel 60 as partially visible in FIG. 2 and as fully visible in FIG. 5 and in various other Figures herein. Mandrel 60 is generally cylindrical in shape and is configured to receive and support an air filter 100 (as visible in FIGS. 4 and 6 and as discussed in detail later herein). Mandrel 60 comprises a first, lower end 61 and a second, upper end 62. In the depicted embodiment of FIG. 5, mandrel 60 is attached to (e.g. is produced in combination with) a bottom disc 52 that is attached to floor 54 of the lower end of lower housing piece 51 (floor 54 is visible in FIG. 4, which is a plan view of the lower portion 50 of the room air purifier, looking downward along the vertical axis of the room air purifier). This particular arrangement is largely a feature of the manner in which the exemplary prototype room air purifier components were made. In some embodiments, no such bottom disc 52 may be needed; rather, the lower end 61 of mandrel 60 may be in direct contact with the bottom floor 54 of lower housing piece 51 (in some embodiments mandrel 60 and lower housing piece 51 may be molded as a single, unitary item). All such arrangements (regardless of whether lower end 61 of mandrel 60 is attached directly to floor 54, or is attached to a bottom disc 52 that is attached to floor 54) are encompassed by the concept of the lower end of the mandrel being “fixed” to the floor and thus to the lower housing portion.

Whatever the particular arrangement, a surface 53 will be provided that is an annular seating surface for a lower surface 86 of a lower resilient gasket 84 as shown in FIG. 5. In the arrangement of FIG. 5, seating surface 53 is an upward-facing surface of bottom disc 52; however, in some embodiments, such a seating surface 53 may be an upward-facing surface of the floor 54 of lower housing piece 51 e.g. if no such bottom disc 52 is present. A lower resilient gasket 84 will thus be used; similarly, an upper resilient gasket 81 will likewise be used (as evident from FIG. 5). The function of these gaskets will be discussed in detail later herein. In the view of FIG. 5, the upper and lower gaskets have been exploded vertically away from their actual installed positions so that the entirety of mandrel 60 may be more easily seen. In actuality, the lower gasket 84 will be disposed on the upward-facing gasket-seating surface 53 of bottom disc 52; gasket 84's position below bottom disc 52 in FIG. 5 is an artifact of the exploding of the various items away from each other.

With reference to FIG. 5, mandrel 60 comprises a radially outward surface 66 which will support an air filter 100 as discussed later herein. Mandrel 60 comprises a lower portion 63 that makes up a majority of the area of the mandrel (e.g. that occupies up at least 70, 80, 90, or 95% of the vertical height of the mandrel) and that is discontinuous so as to be air-transmissive. In many convenient embodiments, portion 63 may take the general form of a “lattice” that is air-transmissive by way of comprising solid members (e.g. bar, struts, beams or the like) 67 that are interspersed with through-openings 68. However, any suitable arrangement may be used (in particular, the air-transmissive through-openings 68 may be of any suitable size and shape). For example, portion 63 may take the form of a screen, as long as the screen comprises sufficient mechanical strength and stability. In various embodiments, lower portion 63 of mandrel 60 will comprise through-openings of sufficient size and/or density so that lower portion 63 exhibits a percent open area of at least 60, 70, 80, or 90.

Mandrel 60 will comprise an upper collar 64 that is located at the upper end 62 of the mandrel. Upper collar 64 provides a suitable location for J-apertures 70 which facilitate the securing of the upper end 62 of the mandrel 60 to the upper portion 20 of the room air purifier as discussed in detail later herein. In many embodiments there may be no direct connection between the upper end 62 of mandrel 60 (e.g., between the upper collar 64 of mandrel 60) and the upper end of lower housing piece 51. That is, in some embodiments the only connection between the mandrel 60 and the lower housing piece 51 may be the above-described connection between the lower end 61 of the mandrel and the floor 54 of the lower housing portion (whether such a connection is direct or via a bottom disc 52).

Upper portion 20 of room air purifier 1 will comprise an upper housing piece 21 and a powered fan 120 as noted. In many embodiments, upper portion may comprise a partition 87, which is most easily seen in FIG. 3 (which is a plan view of the upper portion 20 of the room air purifier, looking upward along the vertical axis of the room air purifier). Partition 87 serves to separate the filtered-air space 89 from space 56 containing air that has not yet been filtered. In many embodiments, a section of the lower surface of partition 87 may provide an annular seating surface 26 for the previously-mentioned upper gasket 81, as evident from FIG. 3.

Partition 87 defines an orifice 88 that will interface with upper collar 64 of mandrel 60 as described later herein to provide that filtered air within interior air space 65 of mandrel 60 can pass through orifice 88 into filtered-air space 89. In order to minimize the chances of unfiltered air being able to enter filtered-air space 89, in many embodiments partition 87 may comprise few or no pathways by which unfiltered air may pass therethrough. In other words, partition 87 may comprise few or no through-holes unless each such through-hole is occupied by an object (e.g. a screw or other suitable fastener) that at least substantially occludes the through-hole. Similarly, the upper housing piece 21 of upper portion 20 may be substantially free of any unoccluded openings that might allow unfiltered air to enter filtered-air space 89 (and/or, partitions may be provided within upper portion 20 to so that filtered-air space 89 is in the form of an air pathway that is isolated within upper portion 20). It will be appreciated that in many embodiments, it may not be necessary to provide an airtight seal at the previously-described junction 57 between the lower edge 59 of upper housing piece 21 of upper portion 20 and the lower housing piece 51 of lower portion 50, since this junction is below partition 87 and any unfiltered air that enters through this junction will merely join the unfiltered air that enters through air inlet(s) 55 to be filtered.

An air filter 100 that can be installed into room air purifier 1 is shown in exemplary embodiment in FIG. 6 (an edge-on view of filter 100 as installed is found in FIG. 4). As installed, air filter 100 will be in generally cylindrical form and will define a generally cylindrical air space 103 therein that will receive the air that is filtered by way of being passed through the filter media 110 of air filter 100. (When the air filter is installed in the room air purifier, air space 103 will generally coincide with the previously-described air space 65 defined within mandrel 60.)

In some embodiments, installation of air filter 100 onto mandrel 60 will involve slidably moving air filter 100 onto mandrel 60, e.g. by positioning a lower end of the air filter over the upper end of mandrel 60 and then sliding the air filter down over the mandrel. (This will be preceded by disassembling the room air purifier into its upper and lower portions 20 and 50 as disclosed herein so that the mandrel is accessible. Also, if the air filter 100 is provided in a compacted, e.g. partially flattened, shape, it will be expanded to its cylindrical shape in order to be slidably moved onto the mandrel.) In some embodiments, mandrel 60 may be slightly tapered (e.g. with the diameter of the upper end 62 of the mandrel being slightly smaller than the diameter of the lower end 61 of the mandrel) to enhance the ease of sliding the air filter onto the mandrel.

When fully installed onto mandrel 60, air filter 100 will be positioned on the mandrel so that at least some portions of radially inward surfaces 104 of the air filter will be in contact with the radially outward surface 66 of the mandrel. If the air filter comprises pleated air filter media as in the exemplary arrangement of FIG. 6, the radially-inward surfaces 104 will be in the form of inward pleat tips of the pleated filter media as indicated in FIG. 6. If the media is pleated, the radially-outward surfaces 105 of the media will be in the form of outward pleat tips, also as indicated in FIG. 6.

The air filter will be positioned on the mandrel (along the vertical/longitudinal axis of the room air purifier and thus of the mandrel) so that when the first and second portions 20 and 50 are joined together to form the room air purifier, the upper and lower edges 101 and 102 of the air filter will be respectively pressed against the lower and upper surfaces 82 and 86 of upper and lower resilient gaskets 81 and 84 as evident from FIG. 5. It is noted that FIG. 5 is arranged to show the relationship between the air filter and the gaskets as installed in the room air purifier; however, the air filter 100 typically will not be supplied with the upper and lower gaskets in place on (e.g. attached to) the air filter. Rather, the gaskets are installed in the upper and lower portions of the room air purifier as discussed later herein and will typically remain with the room air purifier even as a filter 100 is removed and replaced. It is noted further that FIG. 5 depicts upper gasket 81 in partial cutaway so that the upper edges of the air filter media (in this case a pleated air filter media) can be more easily seen. In actuality, gaskets 81 and 84 will be configured so as to seal the entire circumferential extent of the upper and lower edges 101 and 102 of the air filter.

A primary purpose of upper and lower gaskets 81 and 84 is to minimize, e.g. to at least substantially prevent, any leakage of unfiltered air around the upper and lower edges 101 and 102 of the air filter. Accordingly, each gasket should have properties (e.g. resilience and thickness) that allow the edges of the air filter to fit firmly against the gasket and e.g. to slightly deform the gasket to ensure a good seal along the entirety of the air filter edges. In some embodiments, a gasket may be comprised of a solid material of suitable softness and resilience. For example a gasket may take the form of a solid silicone pad (e.g. a ring or annular disc) with a Shore durometer value of less than 50, 30 or 20 on the Shore 00 Scale. In some embodiments, a gasket may be comprised of a similarly soft material that is porous, e.g. an organic polymeric foam material with a Shore 00 durometer value of less than 50, 30 or 20.

In some embodiments, it may be advantageous that a foam gasket material be a closed-cell foam rather than an open-cell foam. That is, such a material, although being porous in the sense of having internal cells, may be a closed-cell material such that the cells are not in sufficient fluid communication with each other to render the material air-permeable. However, in some embodiments a foam material that is used for an upper or lower gasket may be an open-cell foam, as long as the material is arranged to exhibit sufficient airflow resistance.

Thus in some embodiments, an upper gasket and a lower gasket may be airflow-resistive. As used herein, this term signifies that as installed in a room air purifier along with an air filter as disclosed herein, the gaskets will ensure that less than 1% of the air that enters the upper volume of the room air purifier has done so without passing through the filter media. In other words, such a gasket will ensure that 99 (or more) % of the air that passes through the room air purifier, is filtered rather than bypassing the air filter. In particular embodiments, each gasket may be air-impermeable, by which is meant that the gasket will exhibit a Gurley time (a time to pass 50 cc of air through the gasket, along the shortest dimension (i.e. the thickness dimension) of the gasket, using a Gurley densometer available from Gurley Precision Instruments, Troy, N.Y.) of at least 200 seconds. (Many air-impermeable gaskets will exhibit a Gurley time approaching infinity) The testing can be performed according to the methods disclosed in International (PCT) Patent Application Publication WO2018/090280 and in U.S. Pat. No. 6,858,290, the relevant sections of which are incorporated by reference herein.

At least some of the above properties may be intrinsic properties of the gasket material itself; however, it is recognized that at least some extrinsic properties of the gasket may play a role. In particular, the gasket may have a thickness that is sufficient to allow the desired compliance and resilience, but is not so thick as to cause the gasket to occupy too much space. In various embodiments, a gasket may exhibit a thickness of from at least 0.5, 1.0, or 1.5 mm, to at most 8, 6, 4, or 2 mm.

Any such gasket may be positioned as described earlier herein; e.g. an upper gasket 81 may be disposed on an annular seating surface 26 of the upper housing portion and a lower gasket 84 may be disposed on an annular seating surface 53 of the lower housing portion. Such gaskets may typically take the form of annular rings (annular discs) as shown in general manner in FIG. 5. In some embodiments such gaskets may be permanently installed in the room air purifier; e.g. they may be bonded or otherwise attached to their respective gasket-seating surfaces 26 and 53. Or, in some embodiments the gaskets may be removable and replaceable. This may depend on the gasket material that is used, in particular its resistance to compression set. Even for gaskets that are replaceable, it is envisioned that in many embodiments the gaskets may be replaced on a schedule that is less frequent than the schedule at which the air filter is replaced. (Nevertheless, in some embodiments, replacement air filters may be sold as kits that include replacement gaskets.)

By definition, an air filter 100 that is installed in room air purifier 1 is unframed. By this is meant that as supplied to an end user (e.g. a homeowner), the air filter media 110 of air filter 100 is not equipped with any rigidifying support member or members (whether in the form of discrete members, or with the members being connected to each other) that maintain the air filter in a permanently cylindrical shape. In particular, an unframed air filter does not encompass so-called cartridge filters in which a filter media is at least partially within a generally cylindrical rigid support structure. By definition, an unframed air filter as disclosed herein can be compacted (e.g. partially flattened) from a fully cylindrical shape (i.e. a shape in which it is slidable onto a mandrel) into a compacted shape in which the air filter occupies an overall volume that is less than 80% of the overall volume exhibited by the air filter in its fully cylindrical shape (noting that an overall volume means the entire volume defined within the outermost boundaries of the filter media, and includes the volume of the space 103 within the air filter). In other words, an unframed air filter can be compacted to at least significantly reduce the interior volume 103 within the air filter, which can be advantageous for shipping and storage of the filter. By definition, an unframed filter can be compacted in this manner, and then re-expanded to its fully cylindrical shape, without any damage to the filter media or impact on its filtering performance.

In some embodiments, such an unframed air filter 100 may consist of, or consist essentially of, the air filter media 110 itself. In this context, this terminology consist permits the presence of e.g. any ancillary components or materials (e.g. an adhesive or mechanical fastener) as may be needed to take an elongate piece of filter media and join the ends together to form the elongate piece into a cylinder. This also does not exclude embodiments in which the air filter media is a multilayer media. In some embodiments, the corrugated edges of the filter media (edges 101 and 102 as seen in FIG. 5) may be equipped with a flexible sealing material, e.g. a layer of potting material such as a resilient elastomeric material or a resilient nonwoven. Such an arrangement may enhance the ability of the corrugated edges of the filter media to seal against the aforementioned upper and lower gaskets, but will nevertheless leave the pleated filter media in an unframed condition as discussed above.

In some embodiments the lower portion 50 of a room air purifier may include a mesh or screen that is configured to e.g. remove large or gross debris such as pet hair and the like. Such a screen may be e.g. abutted against at least the air-transmissive portions of radially inward surface of lower housing piece 51 and may be removable, washable, and so on. Any such screen will be considered to be a separate item from the herein-disclosed air filter.

The filter media 110 (whether pleated or not) of a disposable air filter 100 may be comprised of nearly any material, in any configuration, that is capable of filtering moving air. Such media may include, but is not limited to, fibrous materials (e.g., nonwoven webs, fiberglass webs, and so on), honeycomb structures loaded with filter media and/or sorbent material, and so on. In particular embodiments, the filter media may include at least one layer that comprises at least some material that can be electrically charged to form an electret material. In particular embodiments, the filter media may be a multilayer media that comprises at least one layer that includes an electret material, and at least one layer that includes a sorbent material. In some embodiments filter media 110 may comprise at least one layer capable of HEPA filtration. In particular embodiments filter media 110 may comprise a prefilter layer e.g. in combination with an electret layer that is capable of HEPA filtration. In some embodiments a multilayer filter media may comprise a layer that serves primarily to enhance the stiffness and pleatability of the multilayer media; such a layer may not necessarily play a significant role in performing filtration.

If at least one layer of the filter media 110 is to be charged, this may be done by any suitable method, for example, by imparting electric charge to the nonwoven web using water as taught in U.S. Pat. No. 5,496,507 to Angadjivand. Nonwoven electret webs may also be produced by corona charging as described in U.S. Pat. No. 4,588,537 to Klaase, or using mechanical approaches to impart an electric charge to fibers as described in U.S. Pat. No. 4,798,850 to Brown. Any combination of such approaches may be used. In various embodiments, filter media 110 may exhibit a % Penetration (using Dioctyl Phthalate as a challenge material, and tested using methods described in U.S. Pat. No. 7,947,142 to Fox) of less than about 50, 40, 30, 20, 10, or 5%.

If at least one layer of the filter media 110 is to exhibit sorbent functionality, any suitable sorbent(s), in any convenient physical form, may be included in such a layer. In particular embodiments, such a sorbent is capable of capturing formaldehyde. In some embodiments, the sorbent includes at least some activated carbon. If desired, the activated carbon may be treated to enhance its ability to capture formaldehyde. Suitable treatments may e.g. provide the activated carbon with at least some amine functionality and/or at least some manganate functionality and/or at least some iodide functionality. Specific examples of treated activated carbons that may be suitable include those that have been treated with e.g. potassium permanganate, urea, urea/phosphoric acid, and/or potassium iodide. Other sorbents that may be potentially suitable e.g. for removing formaldehyde include e.g. treated zeolites and treated activated alumina. Such materials may be included e.g. along with treated activated carbon if desired. In particular embodiments, the sorbent may include materials described in U.S. Provisional Patent Application No. 62/269,613 to Wendland, entitled Polymeric Sorbents for Aldehydes, which is incorporated by reference in its entirety herein.

The one or more sorbents may be provided in any usable form; for example as particles, which may be e.g. powder, beads, flakes, whiskers, granules or agglomerates. The sorbent particle size may vary as desired. The sorbent particles may be incorporated into or onto a layer of filter media 110 in any desired fashion. For example, in various embodiments the sorbent particles may be physically entangled with fibers of a layer of filter media 110, may be adhesively bonded to such fibers, or some combination of both mechanisms may be used.

As noted above, in some embodiments an air filter 100 may comprise a pleated filter media 110 (whether single layer or multilayer) as shown in FIG. 6. In such a case, the pleat direction (PD) of the pleated media will be at least generally aligned with the longitudinal/vertical axis of the room air purifier. The pleat parameters (spacing, depth, and so on) may be any suitable value.

Discussions elsewhere herein make it clear that it can be helpful that the upper and lower edges 101 and 102 of the air filter media be held between gaskets 81 and 84, with sufficient force to minimize any air leaks around the edges of the air filter media. Thus in some embodiments it can be important that the filter media exhibit sufficient stiffness to bear any such force without bending, bowing or buckling. In various embodiments, the filter media may exhibit a Gurley Stiffness of at least 200, 300, 400, 600, 800, or 1000 mg (which is the customary unit for Gurley Stiffness). The Gurley Stiffness will be measured according to the procedures described in U.S. Provisional Patent Application 62/986,300 and in the resulting International (PCT) Application No. IB2021/051400, the relevant sections of both of which are incorporated by reference herein.

It is noted that using a pleated filter media, and in particular aligning the pleat direction of the pleated filter media with the vertical axis of the room air purifier (that is, with the direction along which the gaskets press against the upper and lower edges of the filter media) can allow the media to exhibit much higher resistance to bending, bowing or buckling than might be exhibited by an unpleated air filter media e.g. in the form of a pure cylinder.

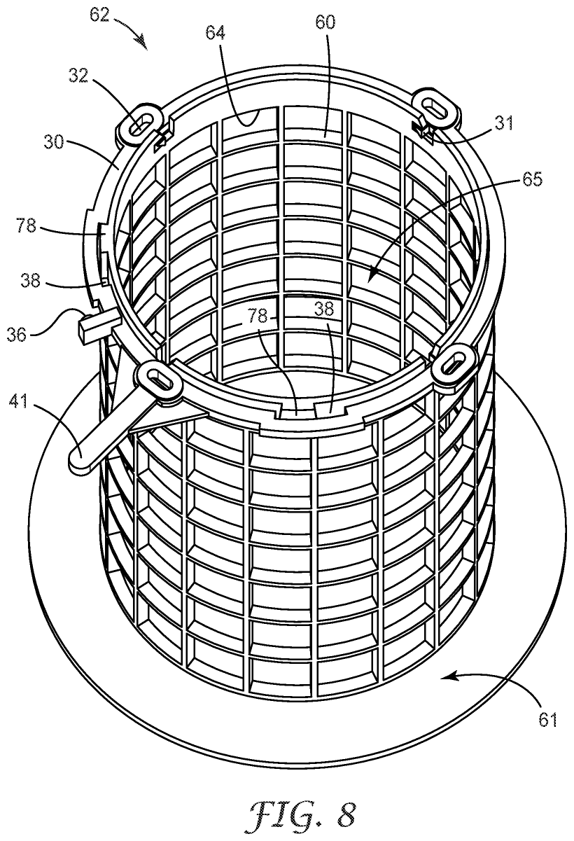

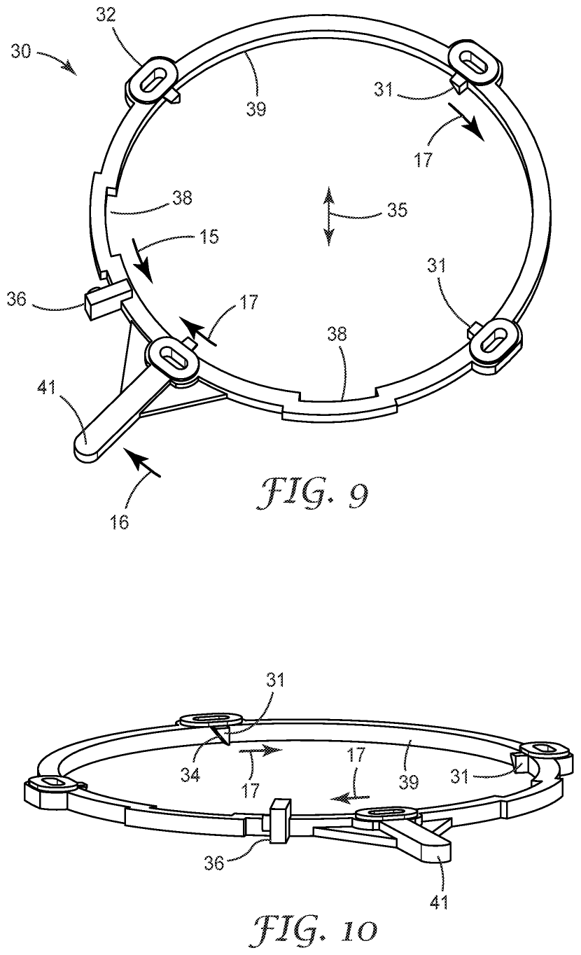

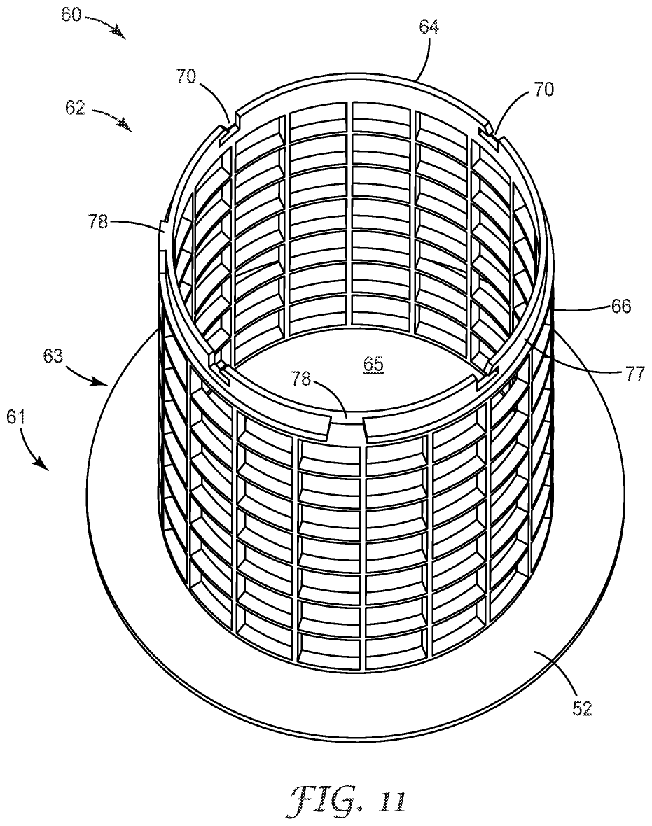

As disclosed herein, first and second (upper and lower) portions 20 and 50 may be joined to each other to form room air purifier 1 by the user of a locking ring 30. An exemplary locking ring 30 is visible in FIGS. 7 and 8 and is shown in isolated view in FIGS. 9 and 10. Locking ring 30 is rotatably attached to first portion 20 so as to be rotatable about an axis of rotation 35 (visible in FIG. 9) that coincides with a longitudinal axis of the room air purifier (such a longitudinal axis will often be the vertical axis of the room air purifier). Locking ring 30 is biased (by a biasing force provided by at least one biasing member) in a first rotation direction 15 as indicated in FIG. 7. In the exemplary arrangement seen in FIG. 7, locking ring 30 is biased in the first rotation direction 15, by way of a biasing force (indicated by arrow 14) applied by a biasing member 37 in the form of a coil spring. (FIG. 7 is a perspective view from generally above, with upper section 23 of upper portion 20 having been omitted so that the lower section 24 of upper portion 20, and locking ring 30 and the upper end of mandrel 60, can be seen.)

As evident from FIG. 7, coil spring 37 is seated against a buttress 29 that is fixed to partition 87 of upper portion 20; the coil spring is held in compression and thus exerts a biasing force (arrow 14) against boss 36 that is attached to locking ring 30. Coil spring thus urges locking ring 30 to rotate in a first direction (counterclockwise, in the view of FIG. 7) indicated by arrow 15. It will however be understood that the biasing of locking ring 30 to rotate in this first direction can be provided by any biasing force derived from any suitable biasing member(s) or arrangement. Such a biasing member might be e.g. a coil spring acting in tension, a torsion spring, a leaf spring, and so on. In some embodiments, such a biasing member may take the form of a member (e.g. a generally U-shaped or V-shaped member that forms a leaf spring) that extends integrally from locking ring 30 and is e.g. injection-molded along with locking ring 30.

In the depicted embodiment, locking ring 30 is rotatably attached to first portion 20 by way of elongate slots 32 (most easily seen in FIGS. 8 and 9) through which are passed the shanks of screws 33 (visible in FIG. 7) that are attached to partition 87 of upper portion 20. Slots 32 are elongate so that locking ring 30 can rotate relative to partition 87 (and thus relative to upper portion 20 as a whole) to an extent limited by the length of the slots. It will be appreciated however that locking ring 30 may be rotatably attached to first portion 20 by many other methods and arrangements. Many such arrangements may limit the amount of rotation to that needed in order to perform the operations disclosed herein. That is, locking ring 30 may not need to be able to perform a complete (360 degree) rotation; all that may be needed is for locking ring 30 to be able to rotate up to e.g. 5, 10, 15, or 20 degrees.

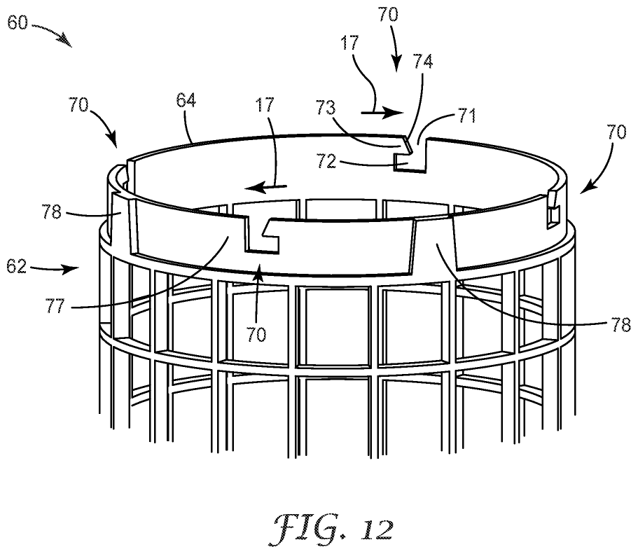

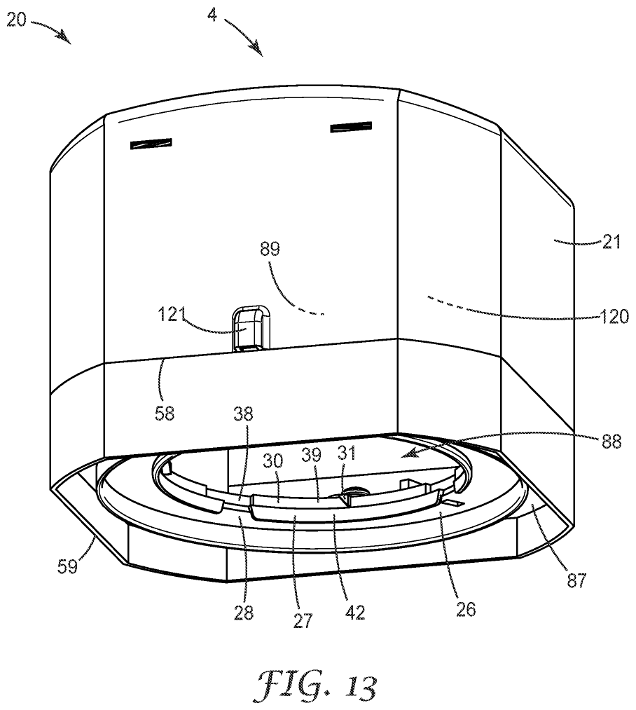

Locking ring 30 comprises multiple (at least two) locking posts 31, most easily visible in FIG. 7. Locking posts 31 extend generally radially inwardly from locking ring 30 and are circumferentially spaced along locking ring 30. In the exemplary arrangement of FIG. 9, four such locking posts 31 are visible, spaced evenly along locking ring 30; any suitable number, e.g. two, three, five, or more, may be used. Locking posts 31 of locking ring 30 work in concert with J-apertures 70 provided in collar 64 of mandrel 60. J-apertures 70 are visible e.g. in FIG. 5 and are shown in further detail in FIG. 12. Each J-aperture is configured to cooperate with a corresponding locking post; thus, in the embodiment depicted in the Figures herein, there are four J-apertures 70 to complement the four locking posts 31. Each J-aperture 70 is configured to accept a locking post 31 so that when the locking posts 31 of locking ring 30 of upper portion 20 are seated within the J-apertures 70 of mandrel 60 of lower portion 50, locking ring 30 secures mandrel 60 to upper portion 20 thus attaching the upper and lower portions to each other to form the room air purifier. As discussed below, the securing of the locking ring to the mandrel is reversible so that the upper and lower portions are detachable from each other.

As seen most easily in FIG. 12, each J-aperture 70 is located in collar 64 of mandrel 60, and comprises an entry slot 71 that faces open-endedly upward in the vertical direction as evident from FIG. 12. The J-aperture further comprises a seating slot 72; it is this seating slot 72 within which a locking post 31 will reside when the locking post 31 is seated in the J-aperture 70. Seating slot 72 vertically underlies a retaining tab 73 of collar 64 of mandrel 60, the retaining tab 73 being circumferentially adjacent the entry slot 71 as is clear from FIG. 12.

Locking ring 30 comprises an actuator (e.g. a handle) 41 as visible in various Figures. So, it is possible to manually (e.g. with fingers) exert force against actuator 41 to overcome the biasing force 14 of biasing member 37, so as to rotate locking ring 30 in a second direction to a position in which the locking posts 31 of the locking ring 30 can enter the entry slots 71 of the J-apertures of the mandrel collar 64. The locking ring can then be moved downward until the locking posts 31 of the locking ring 30 are vertically lower than the retaining tabs 73 of the mandrel collar 64, at which point the manual force on actuator 41 can be lessened so that the biasing force 14 will cause the locking ring to rotate in the first direction 15 which will cause the locking posts 31 to move into the seating slots 72. The physical interference of the retaining tabs 73 of the mandrel collar will prevent any vertically upward motion of the locking posts 31 with the result that the mandrel and the locking ring (and thus the first and second portions) are secured together.

However, in some embodiments, the above-described arrangements can be configured so that no such manual manipulation of the locking ring (e.g. by way of actuator 41) is needed in order to secure the locking ring to the mandrel collar. Thus in some embodiments, each retaining tab 73 of mandrel collar 64 may comprise a circumferential surface 74 that is beveled in a circumferential direction that is opposite the above-described first rotation direction 15 (i.e., the rotation direction that is imparted by the biasing force applied to the locking ring). Such an arrangement is most easily seen in FIG. 12; by beveled in a circumferential direction that is opposite the first rotation direction 15 is meant that surface 74 is sloped in a direction that opposes rotation direction 15 as a path vertically downward along the surface is followed. Similarly, as seen most easily in FIG. 10, each locking post 31 of locking ring 30 may comprise a circumferential surface 34 that is beveled in a circumferential direction that is opposite the first rotation direction 15. By this is meant that surface 34 is sloped in a direction that opposes rotation direction 15 as a path vertically upward along the surface is followed. (It is noted that each definition of a circumferential surface as being beveled applies to that surface alone; the definitions of a beveled circumferential surface of a locking post and a beveled circumferential surface of a retaining tab are not in conflict.)

The result of such arrangements will be clear e.g. from scanning FIGS. 10 and 12. If a locking ring 30 as shown in FIG. 10 is positioned above a mandrel collar 64 (with the locking posts 31 of the locking ring 30 being vertically aligned with the entry slots 71 of the mandrel collar 64), and the locking ring is moved vertically downward relative to mandrel collar 64, the beveled circumferential surfaces 34 and 74 of the locking posts and the retaining tabs will come into contact with each other. Continued downward movement of the locking ring will cause the retaining tabs to exert a force on the locking posts that will urge the locking ring 30 to rotate in a second direction 17 that is opposite the first rotation direction 15 caused by the biasing force. The locking posts 31 can thus travel downward through the entry slots 71, causing the locking ring to rotate as they proceed, until the locking posts are vertically lower than the retaining tabs 73. At this point the retaining tabs will no longer be in contact with the locking posts, so that the above-described biasing force will no longer be opposed by any force exerted by the retaining tabs on the locking posts; the result will be that the locking ring will rotate slightly in the first direction 15 as urged by the biasing force 14, so that the locking posts 31 enter the seating slots 72.

These discussions reveal that in some embodiments the upper and lower portions 20 and 50 can be joined to each other by merely positioning the upper portion above the lower portion with the locking posts of the upper portion vertically aligned with the entry slots of the J-apertures of the lower portion, and then moving the upper portion downward so that the locking posts enter the entry slots. Continued downward motion of the upper portion has the effect that the downward motion of the upper portion is momentarily transformed into rotational motion of the locking ring so that the locking ring will rotate in a second direction 17 caused by the interference of the above-described beveled surfaces. Once the locking posts have been moved so far downward that the camming action of the beveled surfaces ceases, the locking ring will then re-rotate in the first, opposite direction 15 as urged by the biasing force 14. This results in the upper and lower sections being joined to each other merely by the downward movement of the upper portion; there is no need for the user to manipulate the actuator 41. Such arrangements offer an advantageously easy way of assembling the upper and lower portions together to form the room air purifier.

To achieve the above-described auto-locking effects, it may not be necessary to bevel both of surfaces 34 and 74 of locking posts 30 and retaining tabs 73. Thus in some embodiments only the surfaces of the locking posts, or only the surfaces of the retaining tabs, may be beveled. However, beveling the surfaces of both entities may enhance the ease with which the automatic rotating and counterrotating can be achieved and may thus be advantageous in some embodiments. The angle at which each surface is beveled may be chosen to enhance the auto-locking. For example, in the exemplary design shown in FIG. 12, the beveling angle of surface 74 of retaining tab 73 is set at a nominal value of approximately 60 degrees. This beveling angle is relative to the “thrust axis” along which the camming action of surface 74 urges post 31 (and thus ring 30) to move. In the depicted embodiment, the thrust axis is horizontal, thus the beveling angle is relative to the horizontal axis of the apparatus.

Similarly, in the exemplary design shown in FIG. 10, the beveling angle of surface 34 of locking post 31 is set to a nominal value of approximately 60 degrees. Thus in various embodiments, one or both surfaces may exhibit a beveling angle that is at least 30, 40, 50, or 55 degrees; in further embodiments, one or both surfaces may exhibit a beveling angle that is at most 80, 70, or 65 degrees. (If both surfaces are beveled, they will be “oppositely” sloped to achieve the desired camming action.) The dimensions of the locking post and the retaining tab (in particular, the horizontal extent of surface 34 of locking post 31 and of surface 74 of retaining tab 73) can be chosen so that the camming action is effective to rotate locking ring 30 through a specified distance of rotation before the camming action ceases. Similarly, the vertical extent of these surfaces can be chosen so that the auto-rotation occurs over a specified vertical distance of movement of the upper portion of the apparatus relative to the lower portion of the apparatus.

From the discussions above, it can easily be appreciated how the upper and lower portions can be detached from each other e.g. in order to install a replacement air filter. A user merely needs to exert manual pressure on actuator 41 in the direction indicated by arrow 16 of FIG. 7, to overcome the biasing force 14 of biasing member 37, so that the locking ring 30 is rotated in direction 17 so that the locking posts 31 of locking ring 30 are no longer directly vertically underneath the retaining tabs 73 of mandrel collar 64. The upper portion 20 can then be lifted vertically upward, away from lower portion 50, thus separating the two portions.

In the depicted exemplary embodiment, actuator 41 is a handle that protrudes radially outward from locking ring 30 and is accessible through a slot 22 provided in upper housing piece 21, as evident in FIG. 1. However, actuator 41 can take any suitable form and can be arranged as desired. For example, actuator 41 could be in the form of a handle that is shorter (so as not to protrude outward from housing piece 21) with slot 22 being of sufficient width to allow a user's finger to enter so as to move handle 41. Various other actuation arrangements, e.g. push-button, twisting, and so on, may be envisioned; some such arrangements may e.g. convert a largely linear motion (or a twisting motion about some local rotational axis) to the above-described rotation of locking ring 30 about its axis of rotation 35. Furthermore, in some embodiments the actuator and/or locking ring may be configured so that actuator 41 can be temporarily held in an open (unlocked) position (that is, the position into which actuator 41 is moved by applying force as denoted by arrow 16 of FIG. 7). This can provide that the user may not need to constantly apply force to actuator 41 during the process of separating the upper and lower housing pieces. Such arrangements might be achieved e.g. by providing a detent (e.g. a downwardly-extending notch at the left end of slot 22 into which actuator 41 may be moved when it is at the far left end of slot 22). When the disassembly of the upper and lower housing pieces is complete, actuator 41 may be dislodged from the detent notch so that locking ring 30 is again ready to function as described above, when the upper and lower housing pieces are reassembled together. Other detent arrangements may of course be used.

In some embodiments, air purifier 1 and upper and lower portions thereof may exhibit discrete rotational symmetry, meaning that the portions may be joined to each other in any rotational orientation (when looking along the longitudinal/vertical axis of the portions) that allows the locking posts of the locking ring to be aligned with the J-apertures of the mandrel collar. For example, the exemplary air purifier as depicted in the Figures here exhibits a quasi-square shape with four major sides; and, there are four locking posts and four J-apertures, all evenly spaced at 90 degree intervals. If the portions exhibit discrete rotational symmetry, the portions will be able to be joined to each other regardless of any discrete rotation (i.e., 90, 180, or 270 degrees) of the portions relative to each other. Similarly, if the air purifier was e.g. circular and comprised three locking posts and three J-apertures, all spaced at 120 degree intervals, the portions would be able to be joined to each other regardless of any 120 or 240 degree rotation.

In some embodiments, the portions may exhibit discrete rotational symmetry that is partial. For example, for a four-sided, quasi-square room air purifier, the portions might be able to be joined to each other if rotated 180 degrees but not if rotated 90 or 270 degrees.

In some embodiments the portions may be joined to other only when held in a particular orientation relative to each other. In such cases, alignment features may be provided on one or both portions to facilitate the joining. For example, in the exemplary embodiment depicted in the Figures herein, the collar 64 at the upper end 62 of mandrel 60, comprises two alignment tabs 78 that each extend radially outward from collar 64 (tabs 78 are most easily seen in FIG. 11). Locking ring 30, in turn, comprises two alignment slots 38 at which a radially-inward surface of the locking ring is offset radially outward from the radially-inward surface 39 of the remainder of the locking ring (slots 38 are most easily seen in FIG. 9). As evident e.g. from FIG. 8, the alignment tabs 78 must enter the alignment slots 38 in order for the locking ring 30 to be secured to the mandrel collar 64 in the manner described earlier herein. In other words, the presence of such alignment features ensures that locking ring 30 and mandrel collar 64 (and thus the upper and lower portions) must be rotated to a particular orientation in order for the herein-described joining of the two portions to each other to be performed. In the depicted embodiment, the alignment slots and the alignment tabs are provided as pairs (circumferentially spaced apart at approximately 90 degrees). In various embodiments, any number of alignment features, at any desired location and spacing, may be used.

In some embodiments, the above-described arrangements for ensuring alignment may be further modified or adjusted. This can be discussed with reference to FIG. 13, which is a perspective view, looking upward at upper portion 20 from underneath. In FIG. 13, various features that have already been described are visible, including alignment slot 38 in locking ring 30. Also seen in FIG. 13 is a previously undescribed feature which is a small collar 27 that extends downward from partition 87 of upper portion 20. FIG. 13 reveals that collar 27 comprises an alignment slot 28 that is positioned below the above-described alignment slot 38 of locking ring 30. Alignment slot 28 of small collar 27 is also narrower than alignment slot 38 of locking ring 30. This being the case, an alignment tab 78 of a mandrel 60 will have to successfully enter alignment slot 28 before being able to enter alignment slot 38. Thus in such an arrangement, alignment slot 28 of collar 27 will serve as a primary alignment slot with alignment slot 38 of locking ring 30 serving as a secondary alignment slot. In all other aspects, the alignment and mating of the upper and lower portions 20 and 50, and the locking of locking ring 30 to J-apertures 70 of mandrel collar 64, will operate as already described herein.

Another feature of the depicted exemplary embodiment is revealed in FIG. 13. The small collar 27 of partition 87 is configured so that the radially-inward surface 42 of collar 27 is radially aligned with the radially-inward surface 39 of locking ring 30. When the first and second portions 20 and 50 are brought together as described herein, the upper part of mandrel collar 64 will reside radially within surfaces 42 and 39 such that a radially-outward surface 77 of the upper part of mandrel collar 64 radially-inwardly-abuts the radially-inward surfaces 42 and 39 (noting that in the depicted embodiment, mandrel collar 64 is offset slightly radially inwardly from the lower, “lattice” portion of mandrel 60, as evident e.g. in FIG. 12). This overlapping of these entities can serve to more snugly mate mandrel collar 64 to locking ring 30 and to partition 87, thus attaching the upper and lower portions to each other with a minimum of “play”. And, of course, the radially-outwardly-protruding alignment tabs 78 of the mandrel collar must reside in the space collectively provided by alignment slots 28 and 38, in order for the upper and lower portions to mate together.

It will be appreciated that the methods and arrangements disclosed herein are for using a locking ring and associated entities to join first and second (e.g. upper and lower) portions together to form a room air purifier. They are not to be confused with methods and arrangements for holding an air filter in place in a room air purifier. In the arrangements disclosed herein, an air filter is mounted (e.g. slidably mounted) onto a mandrel of a lower portion, after which the mandrel is secured to the upper portion by the locking ring. The mandrel thus supports the air filter, and is also the means by which the lower portion is joined to the upper portion. However, the air filter plays no part in, and is not affected by, the joining of the lower portion to the upper portion, other than that once the portions are joined, the air filter is not able to slidably move along the mandrel because it is positioned in between the previously-described resilient gaskets. It is noted in passing that in some embodiments an air filter may be disposed on the mandrel by being wrapped circumferentially around the mandrel rather than being slidably moved onto the mandrel end-wise. In such embodiments the air filter may be provided to an end-user as a rectangular, generally planar unit (notwithstanding the presence of pleats) rather than e.g. as a flattened cylinder. In such embodiments the air filter may be configured so that after the air filter is wrapped about the mandrel, the circumferential ends of the air filter can attach to each other and/or to some feature on the mandrel to hold the air filter in the desired cylindrical configuration. In some such embodiments, the circumferential end portions of the filter may overlap to minimize any air leaks at the meeting-point of the ends of the air filter.

The arrangements disclosed herein are configured so that with the air filter installed in the assembled room air purifier, the locking ring is not in direct contact with the air filter. That is, the locking ring is not used to “pinch” the air filter against the mandrel collar to hold the air filter (this would be quite difficult in any case with an air filter that is pleated). Moreover, the locking ring is separated from direct contact with the air filter (except for incidental contact as may occur when bringing the first and second portions toward each other) during the process of joining the upper and lower portions together. This means that the locking ring does not apply any torque to the air filter during the previously-described rotation of the locking ring. It will thus be appreciated that the arrangements disclosed herein allow an air filter (in particular, a pleated air filter) to be installed into a room air purifier while minimizing any tendency for the air filter to become twisted by the installation process, which twisting could significantly and deleteriously affect the performance of the air filter.

The discussions herein make it clear that the arrangements disclosed herein result from the interaction of locking posts of a locking ring that is rotatably connected to a first entity, with J-apertures of a second entity. In the above-described exemplary arrangements, the locking ring is connected to an upper portion of an apparatus, which upper portion comprises a fan, motor, and so on. The second entity is a mandrel of a lower portion of the apparatus, which lower portion comprises an air filter that is supported on the mandrel. However, it will be appreciated that all such arrangements may be varied considerably while still relying on the interaction of a locking ring and J-apertures as disclosed herein. For example, an apparatus (e.g. a room air purifier) may be configured so that an upper portion of the apparatus supports an air filter while the lower portion comprises a fan, motor, and so on.

Also, the interaction between a locking ring and another entity need not necessarily occur in the general vicinity of the vertical mid-point of an apparatus as disclosed in the exemplary embodiments herein. Rather, the interaction may occur toward the bottom of a lower portion of an apparatus, or toward the top of an upper portion of the apparatus. Thus for example, a “floor” or “lid” of a room air purifier may be removed in order to replace an air filter, rather than disassembling the room air purifier into two approximately equal-sized halves. Still further, in some embodiments a locking ring may join to an entity that is not necessarily a mandrel that supports an air filter. Rather, such an entity might be e.g. a portion of a housing, a collar provided for the specific purpose of connecting to the locking ring, and so on. It will be appreciated that all such variations are within the scope of the disclosures provided herein.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is any conflict or discrepancy between this specification as written and the disclosure in any document that is incorporated by reference herein, this specification as written will control.

What is claimed is:

1. A room air purifier comprising:
a first portion comprising a first housing piece and a powered fan,
a second portion comprising a second housing piece and a mandrel whose first end is fixed to the second housing piece and that is configured to receive and support an air filter,
wherein with the first and second portions joined together to form the room air purifier, an airflow path through the room air purifier is provided such that air can enter through an air inlet and exit through an air outlet, as motivated by the fan;
wherein the first portion comprises a locking ring that is rotatably attached to the first portion so as to be rotatable about an axis of rotation that coincides with a longitudinal axis of the room air purifier, wherein the locking ring is biased in a first rotation direction, and wherein the locking ring comprises at least two locking posts that extend at least generally radially inwardly from the locking ring and that are circumferentially spaced along the locking ring; and
wherein a second end of the mandrel of the second portion comprises at least two J-apertures, with each J-aperture of the mandrel being configured to accept a locking post of the locking ring of the first portion so that when the locking posts of the locking ring are seated within the J-apertures of the mandrel, the locking ring secures the mandrel to the first portion so that the first and second portions are detachably attached to each other to form the room air purifier.

2. The room air purifier of claim 1 wherein the first portion of the room air purifier is an upper portion with the air outlet and the second portion of the room air purifier is a lower portion with the air inlet, and wherein the first end of the mandrel is a lower end and the second end of the mandrel is an upper end, and wherein the longitudinal axis of the room air purifier is a vertical axis.

3. The room air purifier of claim 2 wherein each J-aperture of the second, upper end of the mandrel comprises an entry slot that faces upward along the longitudinal axis of the room air purifier, and each J-aperture further comprises a seating slot that vertically underlies a retaining tab of the second, upper end of the mandrel, the retaining tab being circumferentially adjacent the entry slot.

4. The room air purifier of claim 3 wherein each retaining tab comprises a circumferential surface that is beveled in a circumferential direction that is opposite the first rotation direction of the locking ring.

5. The room air purifier of claim 3 wherein each locking post of the locking ring comprises a circumferential surface that is beveled in a circumferential direction that is opposite the first rotation direction of the locking ring.

6. The room air purifier of claim 5 wherein the upper and lower portions are configured so that when the upper portion is held above the lower portion and is urged downward against the lower portion, the circumferential surface of each locking post of the locking ring contacts the circumferential surface of each respective retaining tab of the upper end of the mandrel causing the locking ring to be urged to rotate in a second rotation direction that is opposite to the first rotation direction in which the locking ring is biased, allowing the locking posts to move down within the J-apertures until the locking posts are lower than the retaining tab, at which point the biasing of the locking ring causes the locking ring to rotate in the first rotation direction thus causing the locking posts to move into the seating slots of the J-apertures so that the locking posts of the locking ring are seated within the J-apertures of the mandrel thus securing the mandrel to the locking ring and to the first portion.

7. The room air purifier of claim 2 wherein the mandrel comprises a first portion that occupies at least 70% of a vertical height of the mandrel and that is discontinuous so as to allow airflow therethrough in a generally radial direction, and wherein the mandrel comprises a second portion that is above the first portion and that comprises a collar that provides the second, upper end of the mandrel and in which the J-apertures are located.

8. The room air purifier of claim 7 wherein the upper end of the mandrel comprises at least one alignment tab that extends radially outward from the collar of the mandrel, and wherein the locking ring comprises at least one alignment slot at which a radially-inward surface of the locking ring is offset radially outward from the radially-inward surface of the rest of the locking ring, and wherein the upper and lower portions are physically prevented from being joined together unless the at least one alignment tab of the collar of the mandrel and the at least one alignment slot of the locking ring are vertically aligned with each other so that the at least one alignment tab can enter the at least one alignment slot.

9. The room air purifier of claim 2 wherein the collar of the mandrel is sized so that when the first and second portions are attached to each other, a radially outward surface of an uppermost portion of the collar of the mandrel radially inwardly abuts a radially inward surface of the locking ring.

10. The room air purifier of claim 2 wherein the upper portion comprises an upper airflow-resistive gasket comprised of a resilient material, the upper gasket being in the form of an upper annular ring with a major lower surface that is configured to accept an upper edge of an unframed air filter thereagainst; and, wherein the lower portion comprises a lower airflow-resistive gasket comprised of a resilient material, the lower gasket being in the form of a lower annular ring with a major upper surface that is configured to accept a lower edge of the unframed air filter thereagainst.

11. The room air purifier of claim 10 wherein the upper gasket is disposed on a downward-facing gasket-seating surface of the first housing piece of the upper portion, and wherein the lower gasket is disposed on an upward-facing gasket-seating surface of the second housing piece of the lower portion.

12. The room air purifier of claim 2 wherein the locking ring comprises at least one actuator configured so that the actuator can be manually manipulated to urge the locking ring to rotate in the second direction that is opposite the first direction in which the locking ring is biased.

13. The room air purifier of claim 12 wherein the at least one actuator is accessible to fingers of a user of the room air purifier, via a through-opening in the first housing piece of the first portion of the room air purifier.

14. The room air purifier of claim 2 further comprising a disposable, cylindrical, unframed air filter removably installed in the room air purifier, the unframed air filter being disposed radially-outwardly on the mandrel and comprising a pleated air filter media with a pleat direction of the pleated air filter media being aligned with the vertical axis of the room air purifier.

15. The room air purifier of claim 14 wherein the room air purifier is configured so that with the unframed air filter installed in the room air purifier, the locking ring is separated from direct contact with the unframed air filter.

16. The room air purifier of claim 14 wherein the upper portion comprises an airflow-resistive upper gasket comprised of a resilient material, the upper gasket being in the form of an upper annular ring with a major lower surface that is configured to accept an upper edge of an unframed air filter thereagainst;
wherein the lower portion comprises a lower airflow-resistive gasket comprised of a resilient material, the lower gasket being in the form of a lower annular ring with a major upper surface that is configured to accept a lower edge of the unframed air filter thereagainst;
and wherein when the unframed air filter is installed in the room air purifier, an upper edge of the unframed air filter is pressed against the major lower surface of the upper gasket and a lower edge of the unframed air filter is pressed against the major upper surface of the lower gasket.

17. A method of assembling the room air purifier of claim 1, comprising:
positioning the first portion vertically above the second portion, then,
moving the first portion vertically downward toward the second portion so that the vertically downward motion causes the at least two locking posts of the locking ring to contact at least two retaining tabs of the second end of the mandrel so as to urge the locking ring to rotate in a second rotation direction that is opposite the first rotation direction, then,
continuing to move the first portion vertically downward so that the locking posts of the locking ring are located vertically lower than the retaining tabs and are no longer in contact with the retaining tabs so that the retaining tabs no longer urge the locking ring to rotate in the second direction, and,
allowing a biasing force of the locking ring to urge the locking ring to rotate in the first rotation direction so that the locking posts move vertically underneath the retaining tabs so that the locking posts are seated in the J-apertures, thus joining the first and second portions to each other to form the room air purifier.

18. The method of claim 17 further including a preliminary step of slidably moving a disposable, cylindrical, unframed air filter over a radially-outward surface of the mandrel of the second portion so that the unframed air filter is disposed radially-outwardly on the mandrel and so that when the first and second portions are joined together to form the room air purifier, the unframed air filter is removably installed within the room air purifier.

19. The method of claim 17 wherein the locking ring is separated from contact with the unframed air filter during the assembly process so that rotation of the locking ring in the first direction and rotation of the locking ring in the second direction does not apply torque to the unframed air filter.

20. A method of disassembling the room air purifier of claim 1, the method comprising:
manually actuating an actuator to cause the locking ring to rotate in the second direction so that the at least two locking posts of the locking ring are no longer located underneath the at least two retaining tabs of the mandrel, then,
moving the first portion vertically upward so that the at least two locking posts of the locking ring are no longer positioned within the at least two J-apertures of the mandrel, so that the assembled room air purifier is disassembled into the first and second portions.
